(19) United States
(12) Patent Application Publication
(10) Pub. No.: US 2015/0248783 A1
(43) Pub. Date: Sep. 3, 2015

(54) SYSTEM AND METHOD FOR PROCESSING DISPLAYABLE CONTENT TAGGED WITH GEO-LOCATION DATA FOR AUGMENTED REALITY MODES OF VIEWING

(71) Applicant: Owen Fayle, West Windsor, NJ (US)

(72) Inventor: Owen Fayle, West Windsor, NJ (US)

(21) Appl. No.: 14/194,655

(22) Filed: Mar. 1, 2014

(51) Int. Cl. G06T 15/04; G06F 17/30; G06T 5/50; G06T 19/00; G06T 11/60

(52) U.S. Cl. CPC G06T 15/04; G06T 19/006; G06T 11/60; G06T 5/50; G06F 17/30274; G06F 17/30277; G06F 17/30265; G06T 2219/004; G06T 2219/2008; G06T 2215/16; G06T 2210/61

(57) ABSTRACT

Display content is processed as “digital graffiti” for augmented reality viewing. A portable device acquires and displays full motion video representative of the environment externally visible, in real time, to the device bearer. An augmented representation corresponds to that portion of the environment captured by an image acquisition module, which environment encompasses geo-location coordinates. A site of potential interest to the user is situated near a set of coordinates (or along a rectilinear path extending from the location of the device and through the set of coordinates). In a first mode, content (e.g., a video, still photo or graphic image) is geo-location tagged and uploaded to a remote repository. In a second mode, content that another user has associated with respective geo-locations is downloaded and rendered to the display together with the captured external environment in accordance with the orientation of the device and its proximity to those locations.

### BACKGROUND OF THE INVENTION

1. Field of the Invention

This invention relates generally to the processing of display content such, for example, as digital images, motion video sequences, and graphic art, which has been tagged with geo-location and other metadata and, more particularly, to processing such display content to render augmented reality views.

2. Discussion of the Background Art

With the advent of low-cost, portable communication devices equipped with live motion cameras, global position sensing devices, powerful microprocessors, and wireless transceivers, millions of consumers hold within the palms of their hands a tool for unlimited personal expression. Utilizing such mobile terminal devices as smart phones, tablets and notebook computers, such users acquire digital media files corresponding to such display content as live motion video, still photos and graphics and share them with other individuals with whom they are personally acquainted—as by transmission using multimedia messaging services (MMS), or e-mail—or to a broader community using a social network site.

Systems for tagging the display content acquired by a digital camera with geo-location data acquired by an onboard GPS device, together with screen capture metadata are also known. Such digital image capture devices record the time of capture, which is then included in the digital image. Technologies such as the Global Positioning System (GPS) and cellular phone networks have been used to determine the photographer's physical location at the time a digital photograph is taken which is then included in the digital image. For example, the time and location (08-12-07 14:02:41 UTC 42[deg.] 20′ 19.92″ N 76[deg.] 55′ 39.58″ W) may be recorded with the digital image by the digital capture device.

In U.S. Pat. No. 6,914,626 Squibbs teaches a user-assisted process for determining location information for digital images using an independently-recorded location database associated with a set of digital images.

In U.S. Patent Application Publication No. 2004/0183918, Squilla, et al. teach using geo-location information to produce enhanced photographic products using supplemental content related to the location of captured digital images. However, no provision is made for enabling users to tag specific sites of interest with such acquired images, nor to process them as “digital graffiti” as a form of free expression.

U.S. Patent Appication No. US2011/ 044563 filed by Blose et al and published on Feb. 24, 2011 discloses a system in which the images acquired by a GPS-equipped capture device are tagged with geo-location and other metadata and stored where they can be remotely searched and accessed by others, and that the stored images themselves may be augmented with content provided by third parties such, for example, as advertisers. Like Squilla, however, the Bloese et al. system does not allow users to tag specific sites of interest with such acquired images, nor to process uploaded display content as “digital graffiti” which can be downloaded by subsequent portable device users at the same site such that the display content is used to dynamically augment the real time display presented to such users as they move about the area in the vicinity of those sites of interest.

A continuing need therefore exists for systems and methods which may be employed by users of portable devices to associate acquired display content with a site of interest as a form of “digital graffiti”.

A further need exists for systems and methods of enhancing the experience of a broad community of users who subsequently visit the areas proximate to such sites, who may share a common interest, association, affiliation or other connection which does not necessarily require that the users personally know one another.

### SUMMARY OF THE INVENTION

The aforementioned needs are addressed, and an advance is made in the art, by a system which is configured to process display content as “graffiti” in accordance with two distinct modes of operation. The processor of a portable device executes instructions locally which initiate the acquisition and display of an augmented representation of the environment visible, in real time, to the user carrying the portable device. The portable device may be any device adapted to wirelessly exchange display content (e.g., video, still photo images, and graphic images) with a remote storage location, such for example, as a smart phone, tablet, or notebook computer. A transceiver is operated under the control of the processor to exchange communication signals according to the applicable protocol(s) such, for example, as IEEE 802.11, Bluetooth®, CDMA, TDMA, and GSM.

Display content processed in accordance with embodiments of the invention may be exchanged, over a wireless communication network, with a web server associated with a database or distributed network of databases serving as a display content repository. Alternatively, a peer-to-peer arrangement may be utilized wherein display content is exchanged between users of other portable devices that have been configured to execute the same sets of instructions. In variations of the peer-to-peer theme, third parties who are not themselves utilizing portable devices may nonetheless serve previously-processed display content to other users so equipped.

An augmented visual representation initially displayed to a first user, responsive to instructions executed by the processor of the first user's device, corresponds to that portion of the external environment visible to the user which has been captured by an image acquisition module. In some embodiments, the image acquisition module is a live motion camera associated with the device itself, with the environment being displayed as a video sequence in real time and encompassing geo-location coordinates presently in the field of view of the camera. In alternative, “virtual reality” embodiments, the image acquisition module retrieves remotely served compressed video content corresponding to the environment presently visible to the user from a given geo-location but captured at a different point in time. In all embodiments, the portion of the externally visible environment acquired and rendered to the display is updated responsively to the orientation of the image acquisition module.

A site of potential interest to the user is situated near a set of geo-location coordinates. In a first mode, content (e.g., a video, still photo or graphic image) is geo-location tagged and uploaded to a remote repository. To this end, a location acquisition module operative responsively to instructions executed by the processor of the portable device is used to periodically update the location of the user's portable device). In smart phone and tablet embodiments, an onboard GPS sensing module may be used to acquire successive sets of GPS coordinates. In modified embodiments, the power consumption associated with GPS location monitoring is reduced by reducing the frequency of location updates, and supplementing these updates with estimates of direction and distance acquired using an onboard accelerometer. In further embodiments, the location acquisition module is operated under the direction of the processor to retrieve position estimates from a remote server operating on principles of triangulation and/or signal strength measuring techniques. Other metadata besides the geo-location tag which may be associated with display content uploaded in accordance with the first mode of operation includes the identity (or username) of the uploading user, a title assigned by the user, and date of the upload.

In some embodiments, the user is given the option of specifying a remote URL associated with display content in the form of media file(s) available publicly over the world wide web, rather than uploading the display content from memory locally associated with the processor of the portable device. In such cases, a repository database record is created associating the metadata and the external URL address with at least one locally stored, lower resolution of the display content to which another URL address is assigned. For bandwidth conservation reasons, at least a low resolution “thumbnail image” version is preferably stored for initial retrieval to the devices of subsequent users, but any number of intermediate resolution counterparts—as well as high compression versions in the case of video or animated graphic sequences, are also contemplated. A higher number of versions available for the same display content provides a greater degree of flexibility and differentiation and may, for example, enable the user of a tablet or other portable device having a relatively large display, to enjoy an enhanced augmented reality user experience as compared to user of a device having a smaller display—such as a smart phone or watch device. According to some embodiments, where no external URL address is specified, at least a high resolution version of an image is uploaded from a user's device while the user is standing at or near the location he or she wishes to tag.

For carrier implemented embodiments capable of tracing user movements, geo-location tagging of loci—with display content locally generated or specified by the user—can take place remote to the user's location. Alternatively, the user's device acquires a location fix and provides this information with the display content the user wishes to associate with a particular locus. An interest descriptor may optionally be appended to some or all of the media files uploaded by the originating user or assigned automatically as, for example, by image analysis. The interest descriptor serves to classify the display content, allowing subsequent users to apply filtering criteria before any display content is actually retrieved in accordance with a second mode of operation. Other meta data stored with the image can include the name of the originating user (e.g., creator), the date of upload, the title of image, and any comments the user (and any subsequent user) may have appended to record associated with the applicable display content.

According to some embodiments of the present invention, the height of the locus to be tagged may be stored as part of the metadata. By way of illustration, this data could be derived from measurements of tilt recorded by an onboard accelerometer associated with the image acquisition module.

In the second mode of operation, the portable device of a user who subsequently finds himself or herself in the vicinity of a site which one or more users have already associated with uploaded, geo-location tagged display content as “digital graffiti”, renders an augmented real-time display which is responsively adapted in real time to the geo-location and bearing of the image acquisition module of the device. According to embodiments of the second mode of operation, a processor of the user's portable device executes instructions which direct the location acquisition module to acquire the current position of the device.

Further instructions executed by the processor cause remotely stored, geo-location tagged display content—at least some of which has been associated with one or more sites within a defined range of the device as “digital graffiti” through operation of another user's portable device—to be retrieved and locally stored. In some embodiments, the storage is within the memory of the retrieving device. In other embodiments, however, the display content is stored in an adjunct memory module operatively associated with the retrieving device. Data stored locally as part of the retrieval process includes the display content media file(s) associated with each geo-location, the title assigned to the file by a user, the name or “handle” of the person who associated the display content with a specific location, the source address (e.g., URL) of the display content media file(s), and the date on which the association was made by the other user.

In some embodiments, display content is made available for retrieval in alternative formats. By way of illustrative example, a still photo or graphic image is made available as a low resolution “thumbnail” image and as a high resolution image, while a motion video or animated image sequence is made available as a “thumbnail image”, a high compression video sequence, and as a low compression video sequence. The processor of the retrieving portable device constructs a display content location array, calculating the distance and bearing of each geo-location tagged media file. To minimize bandwidth usage and processing resources, media files of the lowest resolution and/or highest compression are downloaded unless and until rendering of higher resolution media files is appropriate.

The display content or image acquisition module, which in exemplary embodiments is implemented as a live motion camera, acquires digital representations of the scenes visible to the user based on the direction at which the module is pointed. For each image in the display content array, values for the opacity, size and scale, border color and vertical height are updated responsively to the current bearing and distance between the user and the geo-location specified for that image. A Z_{index} value, corresponding to the priority in which display content is rendered to the display, is set using the distance information.

The values in the display content array are updated responsive to the retrieving device being moved beyond a given distance threshold. Based on the direction at which the image acquisition module is oriented, (i.e., the device field of view captured by the image acquisition module) the content selected from the array for display is updated. A higher resolution image is retrieved once the location associated with specific tagged content is within a predefined distance. In touch screen embodiments of the present invention, when the location associated with specific display content is within this predefined distance, a “touch event listener” will monitor the user interface superimposed upon the display to determine whether the retrieving user has elected to view such content in full size or at a lower level of compression, as the case may be. Other items which may be optionally rendered to the display responsively to a touch event include comments about the locus or image made by other users, as well as a field for the user to enter and upload his or her own comments.

Additional features and advantages of the invention will be set forth in the detailed description which follows, and in part will be readily apparent to those skilled in the art from that description or recognized by practicing the invention as described herein, including the detailed description which follows, the claims, as well as the appended drawings. It is to be understood that both the foregoing general description and the following detailed description are merely exemplary of the invention, and are intended to provide an overview or framework for understanding the nature and character of the invention as it is claimed.

### BRIEF DESCRIPTION OF THE DRAWINGS

The aspects of the present invention will become more apparent by describing in detail illustrative, non-limiting embodiments thereof with reference to the accompanying drawings, in which like reference numerals refer to like elements in the drawings.

FIG. 1A is block schematic diagram depicting an exemplary network topology for implementing the site “tagging” and augmented reality view rendering functionality according to embodiments of the invention;

FIG. 1B is a block schematic diagram depicting an exemplary portable communication device for practicing embodiments of the present invention;

FIG. 2 is an enlarged view depicting one of the zones shown in FIG. 1A, the zone containing a geographically distributed number of sites, represented as loci in dimensional space (e.g., GPS coordinates) and tagged by images selected by participating users or other parties;

FIG. 3A is a table which depicts a representative sample of distributed loci within the zone illustrated in FIG. 2;

FIG. 3B is a further enlarged view of a circular area, within the zone of FIG. 1A, and depicts the distribution of loci from the table of FIG. 2 relative to a user standing at position P₁;

FIGS. 3C-3E depict, for respective orientations of a portable device carried by the user standing at position P₁ in FIG. 3B, a digital representation of a portion of the external environment visible to the user in the direction of the corresponding loci represented in FIG. 3B;

FIG. 4A is a simplified view of the illustrative zone depicted in FIG. 1A, limited to loci within a specified distance from any of three points along a path traversed by a user carrying a portable device configured in accordance with the exemplary embodiments of the invention;

FIG. 4B is a table containing some of the data stored in a database associated with a display content repository such as the one exemplified by FIG. 1A and accessible, by way of illustrative example, over a wireless communication network, the tabulated data corresponding to the loci depicted in FIG. 4A;

FIG. 4C is a table containing a subset of the data from FIG. 4B, the loci from that table being organized—following retrieval by the applicable portable device—in a locally stored array as a function of distance from the three specific user positions identified in FIGS. 4A and 4B;

FIG. 5A is a further simplified view of the illustrative zone depicted in FIG. 1A and FIG. 4A, limited to the arrangement of a specific set of display content loci relative to a single position of the user carrying a portable device configured in accordance with exemplary embodiments of the invention;

FIG. 5B is a table containing a subset of the data depicted in FIG. 4B limited to that pertaining to data retrieved by a portable device associated with the user standing at position P′₁, sorted from farthest to closest for each of the three discrete angular orientations relative to that position shown in FIG. 5A;

FIGS. 5C-5E depict, for the angular orientations relative to P′₁ depicted in FIGS. 5A and 5B, a respective digital representation of a portion of the external environment visible to the user in the direction of a corresponding angular orientation;

FIG. 6A is a further simplified view of the illustrative zone depicted in FIG. 1A and FIG. 4A, limited to the same set of display content loci shown in FIG. 5A but with reference to different set of identified angular orientations;

FIG. 6B is a table containing a subset of the data depicted in FIG. 5B limited to that pertaining to data retrieved by a portable device associated with the user standing at position P′₁ , sorted from farthest to closest for each of the three discrete angular orientations relative to that position shown in FIG. 6A;

FIGS. 6C-6E depict, for the angular orientations relative to P′₁ depicted in FIGS. 6A and 6B, a respective digital representation of a portion of the external environment visible to the user in the direction of a corresponding angular orientation;

FIG. 7 is a flow chart depicting multimode operation of a portable device to exchange geo-tagged media files representative of digital graffiti with another device or remote content server according to embodiment of the present invention;

FIG. 8 is a flow chart depicting a sequence of sub steps making up one of the steps depicted in FIG. 7; and

FIG. 9 is a flow chart depicting a sequence of sub steps making up one of the sub steps depicted in FIG. 8.

### DETAILED DESCRIPTION

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular and/or plural in referring to the “method” or “methods” and the like is not limiting.

The phrase, “display content”, as used herein, refers to any digital media file, such as a digital still image, a digital video file, still graphics such as logos and the like, and animated graphics. It should be noted that, unless otherwise explicitly noted or required by context, the word “or” is used in this disclosure in a non-exclusive sense.

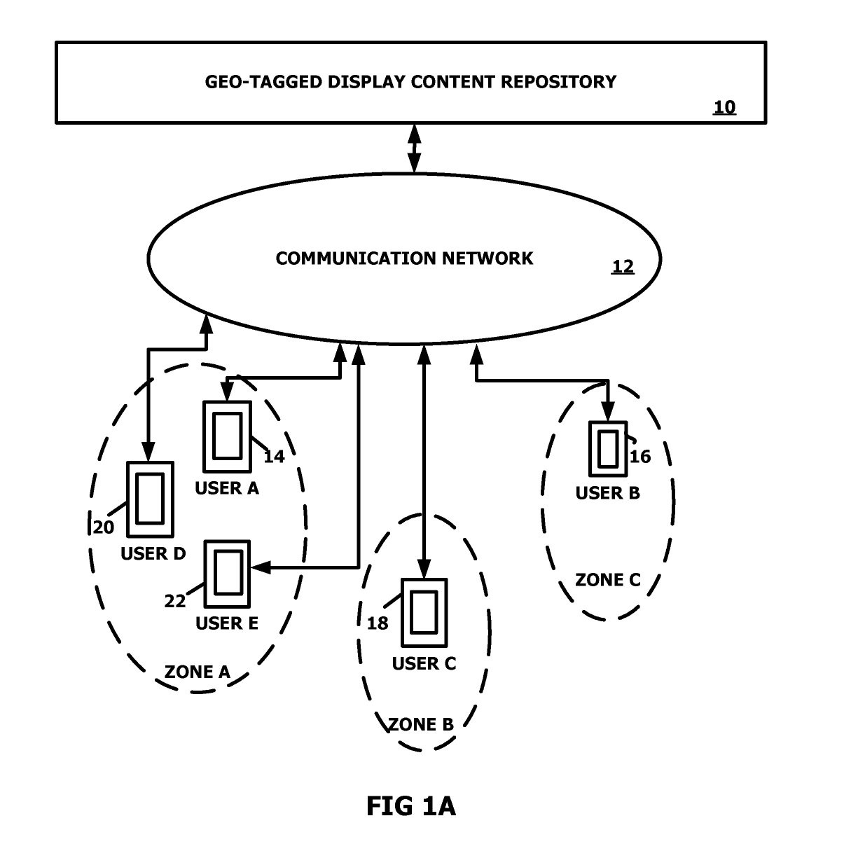

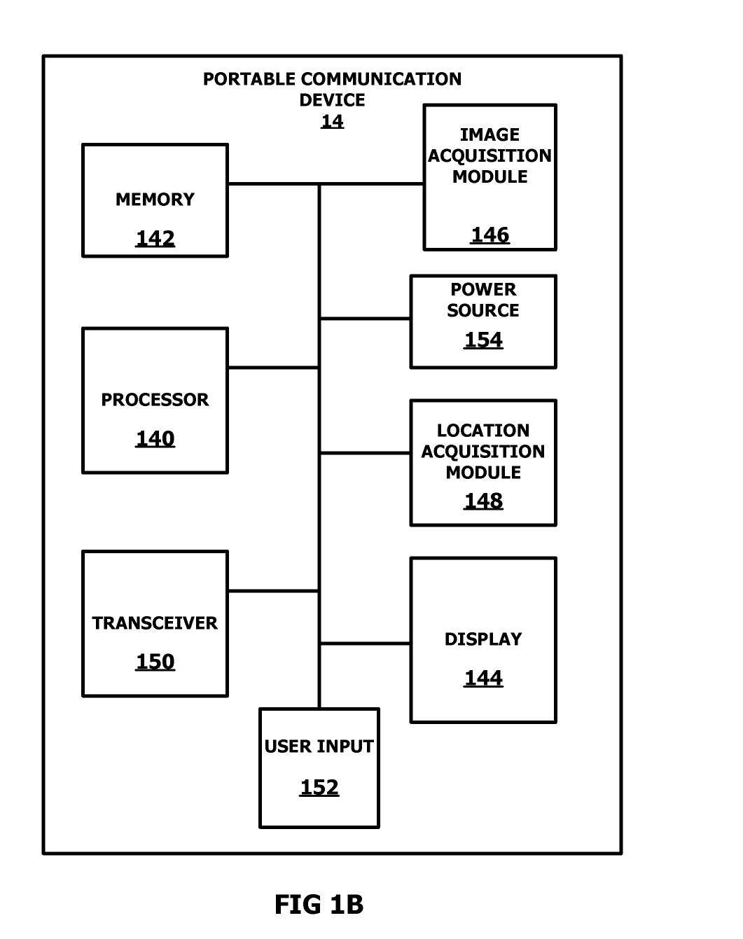

With reference now to FIG. 1A, the “tagging” of sites of interest with display content corresponding to “digital graffiti” by a user—and the subsequent rendering of such display content as part of displayed live motion scenes of the externally visible—will now be described. FIG. 1A illustrates a system 100 for processing display content tagged with geo-location data as “digital graffiti” according to exemplary embodiments of the present invention. In its most basic form, system 100 includes a data processing repository indicated generally at reference numeral 10 configured to exchange geo-location tagged media content with a community of users, such as USER A, USER D, and User E carrying portable communication systems 14, 20 and 22, respectively within Zone A, USER C carrying portable communication system 18 within Zone B, and USER B carrying portable communication system 16 within Zone C.

In the particular embodiment shown in FIG. 1A, display content is exchanged wirelessly over a communication network indicated generally at reference numeral 12. By way of illustration, communication network 12 can be configured as a wide area network (WAN) that includes a conventional wireless network—utilizing a known protocol such as code division multiplexing access (CDMA), time division multiplexing access (TDMA), or the global system for mobile communications (GSM) to which access is granted by a carrier on subscription basis. In addition, or by way of alternate example, the display content may traverse a WI-FI communication system relying upon a distributed network of access points and a ubiquitous LAN protocol such as an IEEE 802.11 to reach an internet service provider gateway.

In the illustrative embodiment of FIG. 1A, the geo-tagged display content repository resides in at least one database (not shown) and is accessible through an associated web server (not shown). In a conventional manner, the web server is configured with a memory (not shown) which contains instructions executable by a processor. As will be described in greater detail later, these instructions regulate the association of each digital media file uploaded by a user with a file name, location data, and such optional metadata as the author's (or source's) name or “handle”, the date of upload, the URL location of each file, its resolution and any other file attributes.

For redundancy and/or load balancing reasons, multiple server and database locations may be employed. In the illustrative embodiment of FIG. 1A, for example, three different database/web server installations may be used to server Zones A, B and C, respectively. If user authentication is to be performed before granting a user access to the upload or download facilities of the database(s), an authentication server (not shown) may be situated at still another location or it may be co-located with any of the aforementioned installations.

It should be noted that although the discussion to this point has been limited to centralized or distributed database facilities accessible over a wide area network infrastructure, the inventor herein contemplates that peer-to-peer implementations of the invention are also possible. For example, a first user who has tagged a site in a given park, community, or city, may come within wireless transmission range of other users who are equipped with portable communication systems configured to implement the augmented reality features of the present invention. In such situations, the memory and processor of the first user's portable communication system could perform the same functions as analogous components associated with the geo-tagged display content repository 10 depicted in FIG. 1A. Moreover, in further variations of this peer-to-peer theme, third parties who are not themselves utilizing portable communication systems may nonetheless serve previously-processed display content to other users via, for example, fixed terminals configured as peer-to-peer endpoints.

In any event, and turning now to FIG. 1B, there is shown an exemplary embodiment of a portable communication system, as system 14 carried or worn by USER A. As shown in FIG. 1B, system 14 includes a processor 140 operative to execute instructions stored within memory 142. The instructions stored in memory 142 typically include govern the function of other components of system 14 such, for example, as display 144, image acquisition module 146, location acquisition module 148, wireless transceiver 150, and user input controls 152 (e.g., touch screen interface, keyboard, voice recognition actuated microphone, and remote peripherals). A battery or other power source 154 provides power to the device.

In the particular embodiment depicted in FIG. 1B, the aforementioned components of communication system 14 are situated within a common housing. Portable communication systems which combine most, if not all of these components are now ubiquitous and relatively inexpensive. They include smart phones and tablets (including, but not limited to, those running the Android operating system or Apple IOS), portable digital assistants (PDAs), wearable computers such as Google Glass® and Galaxy Gear®, notebook computers, and laptop computers. In most cases, the functions of the image acquisition module 146 to be described hereafter are implemented by an onboard, live motion camera, while those of the location acquisition module 148 are implemented by an integral GPS sensor and antenna. It will, however, be readily appreciated by those skilled in the art that the various components of system 14 depicted in FIG. 1B need not be located in a single housing nor need they be limited to the types of devices exemplified above. By way of alternate example, system 14 may be a wearable collection of devices connected to one another by wires, through a suitable wireless protocol such, for example, as the well known Bluetooth protocol, or any combination of these.

With continued reference to FIG. 1B, then, it suffices to say that processor 140 is adapted to execute instructions for controlling a host of disparate devices which collectively deliver the functionality soon to be described. To this end, memory module 142, or an additional memory module communicatively coupled to processor 142, contains the necessary instructions for processing display content according to embodiments of the invention,

FIG. 1A is block schematic diagram depicting the implementation of embodiments of the present invention in which portable device users tag” sites of interest with “digital graffiti” and wherein the processors of portable devices respectively carried by corresponding users in the vicinity of the tagged sites are execute locally stored program instructions to generate and display an augmented view of the external environment which incorporate the digital graffiti;

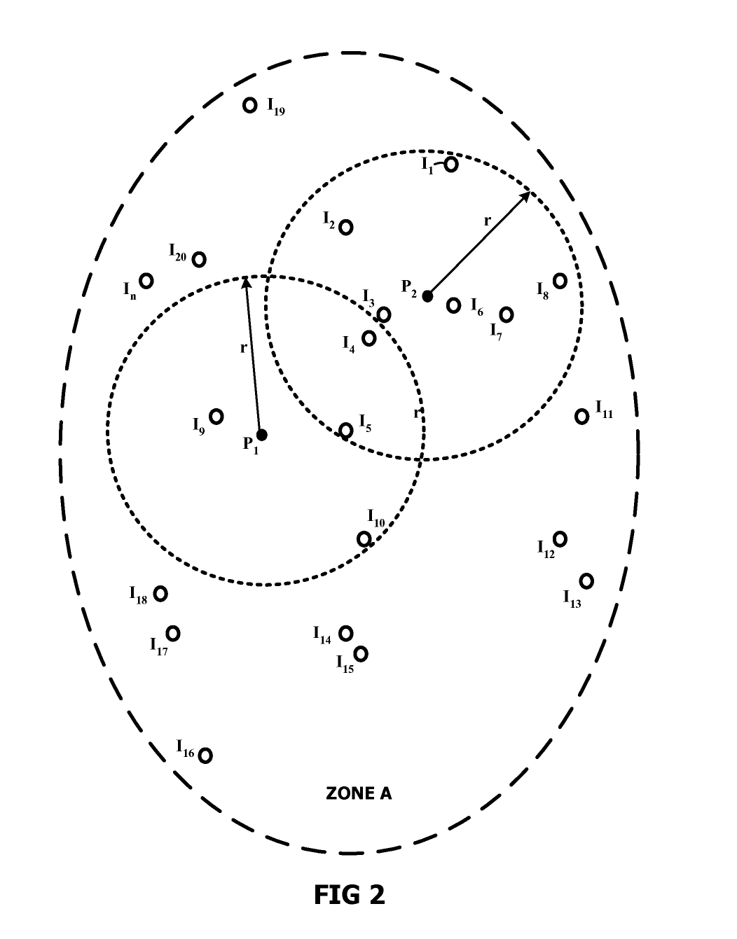

With simultaneous reference to FIGS. 1A through FIG. 2, there is shown an enlarged view depicting in expanded and greater detail, a dispersion of loci within Zone A of FIG. 1A. These loci or “sites of interest” are indicated generally at I₁ through Iₙ, Through a process which will be described in greater detail shortly, users of portable communications systems 14-22 have uploaded geo-location tagged digital media files such as images, live motion video, and still photos for storage at a remote facility such as repository 10. In this regard, the manner in which these media files are acquired by a device as device 14 prior to uploading is subject to great variation. The content may have been locally authored by User A using, for example a graphics editor program, it may have been download from another location, or it may have been acquired locally by image acquisition module 146 (FIG. 1B).

At this point, it suffices to say that along each media file uploaded, a portable communication system configured in accordance with embodiments of the invention will upload or otherwise provide an associated geo-location in three-dimensional space for storage in repository 10. Any conventional method for acquiring and periodically updating the location of system 14 may be used. In cases where the location acquisition module is an onboard GPS sensor and antenna, for example, a geo-location “fix” is acquired at the time of the first media file upload at a given location and this is transmitted along with the file. Alternatively, system 14 can acquire its location—with varying degrees of accuracy—through triangulation, local single strength measurements or through a location fixing service provided by a mobile network carrier. Indeed, in some embodiments of the invention, a processor (not shown) associated with the web server of repository 10 may be configured to implement instructions to retrieve a location fixed directly from the location fixing service. Out of privacy concerns, however, such operations may require the applicable user to furnish prior authorization and for the server to provide authentication credentials as part of the request.

It will be noted that some of the loci depicted in FIG. 2 are circumscribed by one of two areas having a radius r. These two areas surround two distinct points—one corresponding to the point P₁ at which User D is standing and the other to point P₂ at which User A is standing. As will be explained shortly, when a processor of portable communication system carried by User D is executing instructions for retrieving and displaying an augmented reality view on the display of system 20, he or she will be able to see a digital representation of the externally visible environment. When system 20 is pointed in the direction of locus I₉, for example, the scene rendered to the display includes not just the live motion feed coming from the image acquisition module, but also one or more thumbnail images that one or more other users have associated with that locus through a prior uploading process. In like fashion, when a processor of portable communication system 14 carried by User A is executing instructions for retrieving and displaying an augmented reality view on the display of system 14, he or she will be able to see a digital representation of the externally visible environment. When device 20 is pointed in the direction of locus I₇, for example, the scene rendered to the display 144 includes not just the live motion feed coming from the image acquisition module 148, but also one or more thumbnail images that one or more other users have associated with locus 6 as well as those of locus 7 which from the perspective of position P₂ lies behind and a degree or so to the left of locus 6.

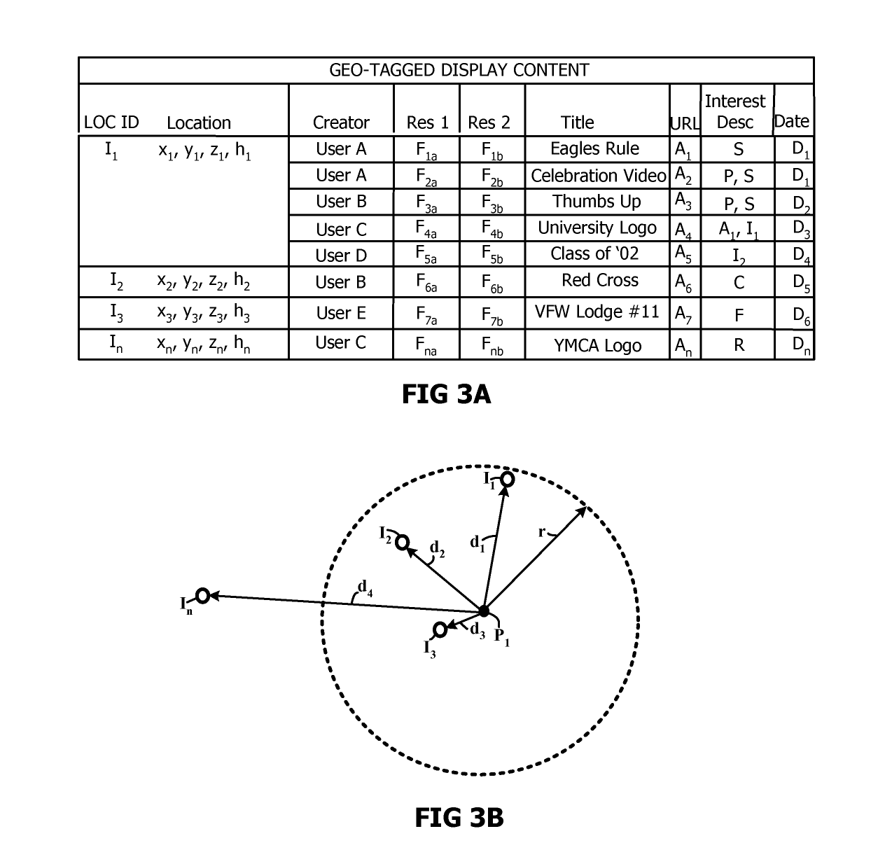

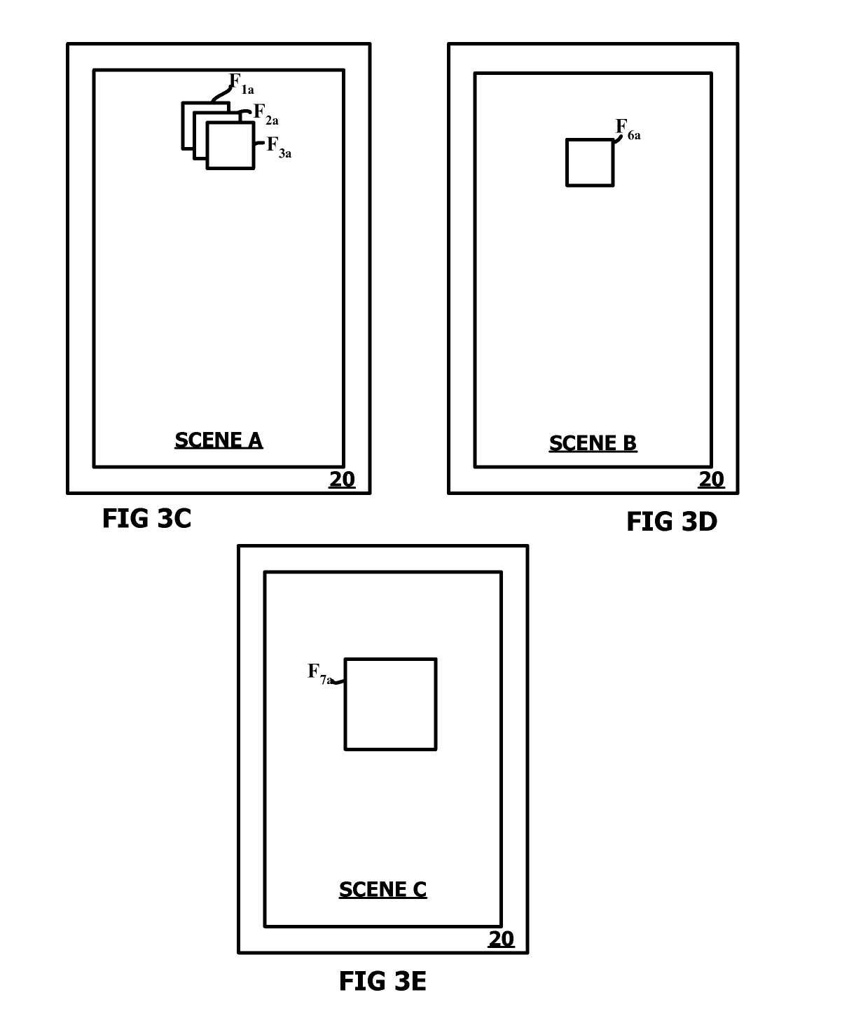

FIG. 3A, there is shown a table which depicts geo-location and meta data retrieved from repository 10 for those loci within Zone A of FIG. 2 which are distributed within the circumscribed region of radius r about point P₁, In recognition of the finite storage, processing and display capabilities of many portable communication systems including, but not limited to, smart phone devices, both a distance and an absolute file number threshold limit is preferably set in the application program executed by a processor as processor 140 of system 14. In the exemplary embodiment, radius r is set to a distance of 0.50 miles (−800 m). If more than 100 media files would otherwise be applicable to the loci within the circular region so defined, then only the closest 100 images are downloaded Of course, as the storage and processing power of portable communication systems as systems 14 and 20 improve, these limits can be relaxed. Additionally, some of the images may be stored locally on a persistent basis—particularly for those users who are tied to a given geographical region. Accordingly, embodiments of the invention are configured to allow the User to specify a home area or to estimate a home location and allocate a user authorized amount of memory to accommodate persistent storage of media files most commonly processed when the program is executing.

In any event, and with continued reference to FIG. 3A, it will be seen that the tabulated data includes for each of the loci I₁ to Iₙ, the location in three dimensional space as represented, for example, by a set of GPS coordinates. Additional data in repository 10 made available for download includes the title ascribed to each media file by a user, the name or handle of the user who uploaded the media files, at least a high resolution/low compression version of each digitally represented image, photo and live video sequence and, optionally, a low resolution/high compression version as well. Persistent storage of low resolution/high compression versions of each media file within the database of repository 10 is not necessary insofar as it is possible to generate such a version upon demand. As will soon become evident, however, considerable savings in bandwidth, power consumption, processing speed, and memory resources are obtained by configuring the devices to retrieve only a low resolution version of each image as images F_{1A} through F_{1B} shown in the table of FIG. 3A. An exemplary resolution for low resolution images may be 75×75 pixels . Higher resolution may be on the order of from 500×333 to even 1023×683 pixels. If further flexibility is desired to, for example, accommodate the disparate display sizes and capabilities of disparate portable communication systems, any number of intermediate resolution versions can also be accommodated. Where the thumbnail corresponds to display content in the form of a video sequence, a representative thumbnail image is selected in a conventional manner at repository 10 (FIG. 1A).

FIG. 3B is a further enlarged view of the circular area, within Zone A of FIG. 1A, and depicts the distribution of loci from the table of FIG. 2 relative to User E standing at position P₁ and carrying portable communication system 20. As seen in FIG. 3B, loci I₁, I₂ and I₃ are separated from point P₁ by distances d₁, d₂ and d₃, respectively. Locus In, on the other hand, lies outside the circumscribed boundary and is separated from point P1 by a distance of d₄.

In some embodiments, provisions are made for users to assign an interest descriptor. Examples of these in the table of FIG. 3A include the designation of an alumni association exemplified by descriptor A₁, a professional or collegiate sports team or league, indicated by the descriptor S, a personal network descriptor P wherein the user may have a predefined circle of friends to whom the rendering of augmented display containing that content will be limited, a charitable institution descriptor C, a fraternal organization descriptor F, and a religious organization descriptor R. Of course, any number of such descriptors may be defined, the goal being to give the community of users greater flexibility in choosing which media files to download and process. An additional classification may relate to advertising, wherein those users who elect not to access media files of repository 10 on a subscription basis may be served with media files corresponding to advertising content, virtual billboards, and other messages of a commercial variety.

In the example depicted in FIG. 3A, one of more popular loci, I₁ is a stadium where a professional football team plays its home games. As shown in the table, locus I₁ has five separate media files associated with it, with User A submitting both a graphic logo and a video of friends taken after a big win. FIGS. 3C-3D depict, for respective orientations of a portable device carried by User E standing at position P₁ in FIG. 3B, a digital representation of a portion of the external environment visible to the user in the direction of each of the corresponding loci represented in FIG. 3B. User E has elected to render only that graffiti which relates to a professional sports team, according to the interest descriptor “S”. Thus, for example, in FIG. 3C, rendered together with the live motion video fed from image acquisition module 146 are low resolution thumbnail images indicated generally at reference numbers F_{1A}, F₂ₐ and F₃ₐ. Images F4a and 4b, which do not have a sports interest descriptor associated with them, are not visible display 3C. Because the locus I₁ is right near the boundary marked by radius r, the images associated with this locus appear relatively small and near the upper part of the rendered scene A shown in FIG. 3C. Likewise, because portable communication system 20 is aimed directly at locus I₁, the cluster of rendered thumbnails appears in middle from left to right.

Likewise, when the portable communication system 20 carried or worn by User E at position P₁ is angularly reoriented from the direction facing locus I₁ to face the direction of locus I₂, low resolution image F₆a is rendered and, being relatively far away (near the outer boundary), it too appears small and at the center of the display screen. Combined with the live video input of an image acquisition module, the result is the rendering of Scene B in FIG. 3D. When reoriented yet again to face the direction of locus I₃, it is the low resolution image F_{7A} shown in FIG. 3A which appears in the live motion scene rendered to the display of device 20. In this example, the distance d3 by which locus I₃ is separated from User E at point P₁ is substantially closer. According to embodiments of the invention, which will soon be described, the size, scale and other visual attributes of the respective images are variable in accordance with the proximity of the system and associated user to the corresponding locus. Here, the Scene C rendered to the display of FIG. 3E is still in the center but appears substantially larger.

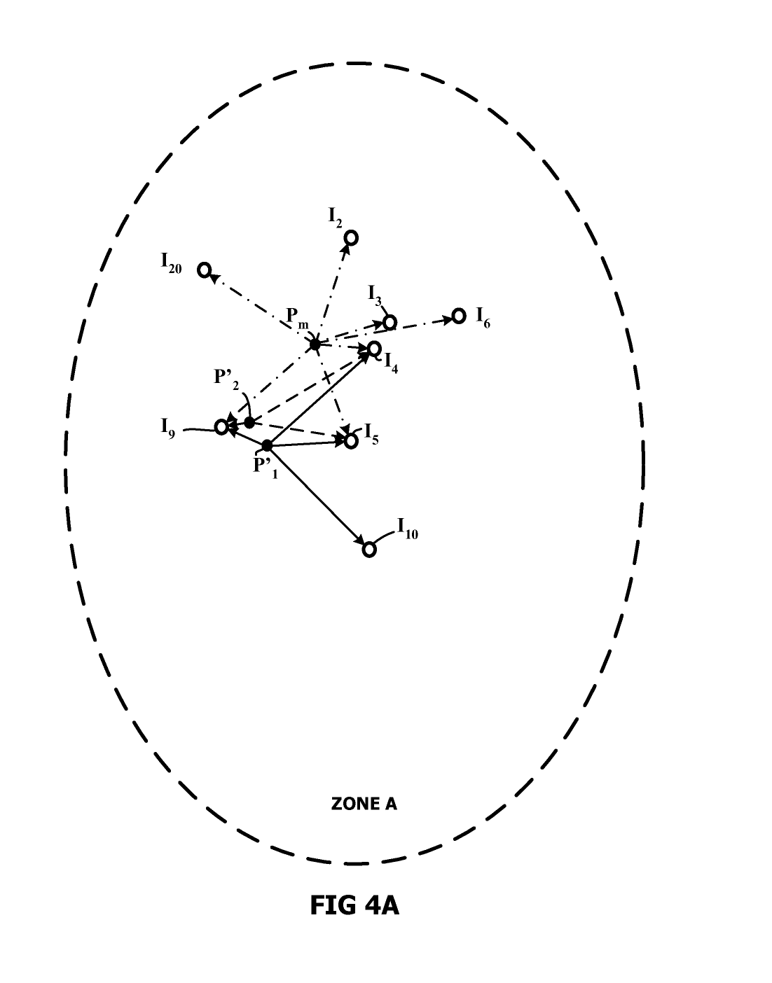

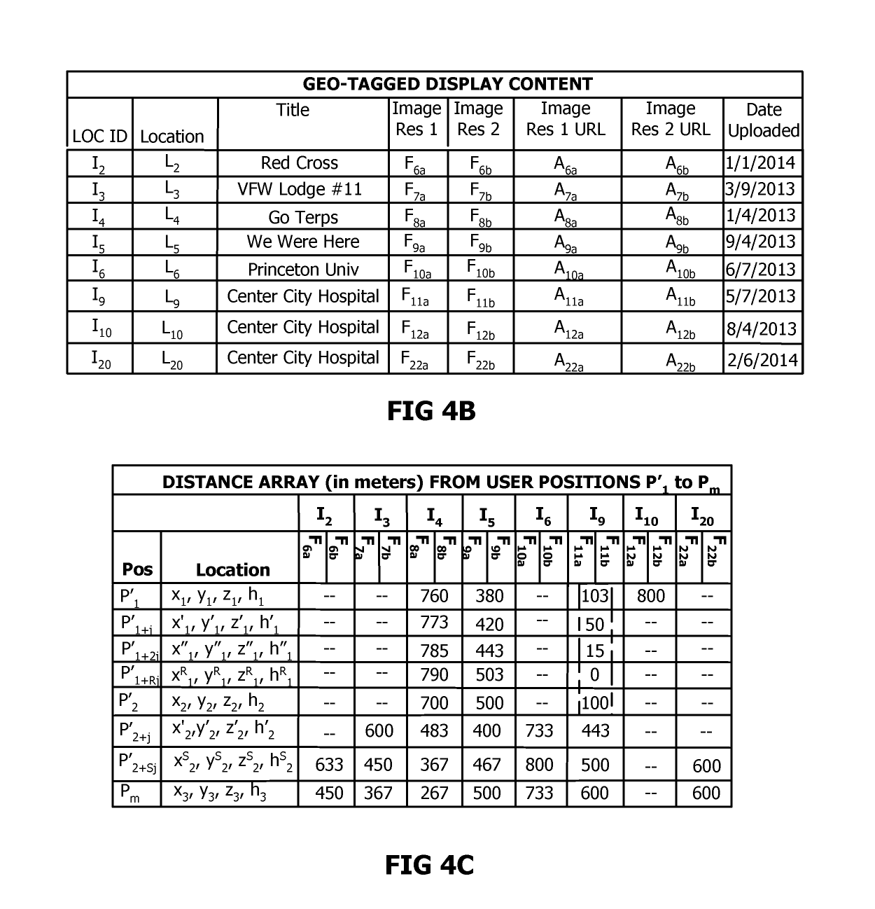

FIG. 4A is a simplified view of the illustrative zone depicted in FIG. 1A, limited to loci within a specified distance from any of three points indicated generally at P′₁, P′₂, and P′ₘ along a path traversed by a user carrying a portable device configured in accordance with exemplary embodiments of the invention. From position P′₁, loci I₃, I₅, I₉ and I₁₀ lie within the circumscribed radius ᵣ heretofore described but not shown in FIG. 4A. From position P′₂, loci I4, I₅ and I₉ lie within the prescribed boundary . From position P′ₘ, loci I₂, I₃, I₄, I₅, I₆, I₉ and I₂₀ are within the circumscribed radius r.

It should be emphasized that although only three points P′₁, P′₂, and P′ₘ are depicted in FIG. 4B, such depiction is merely for clarity of explanation and ease of illustration. In realty, the location acquisition module of systems operated by a user in accordance with the teachings of the present invention, as devices 14-22 of FIGS. 1A, is operative to acquire new location information at regular time intervals. With reference to the device 14 of FIG. 1B, processor 140 in some embodiments is configured to acquire location information every t seconds, where t has a positive value greater than zero but need not be a whole number. The precise value of t admits of substantial variation given that some users may walk faster than others, but in t is preferably set—by the instructions executed by processor 140—at a value low enough to acquire location information each time the user carrying or wearing the device has moved a distance of j meters. An exemplary number value of j which has been determined to work well for the purposes of the invention is 15, though here again the precise value is deemed by the inventor to admit of substantial variation and may be on the order, for example of 0.5 meters to 20 meters (depending upon the accuracy of the location fixing technique employed.

In some embodiments, the instructions loaded in memory and executed by a portable communication system as system 14 of FIG. 1B enable the location acquisition module 148 to preserve power by acquiring a number of estimates of location between each measurement of location. The acquisition of GPS measurements, for example, consumes considerable power and might quickly drain the energy from power source 154 if it were to be operated continuously. One suitable technique for configuring location module 148 to acquire estimates in accordance with embodiments of the invention is described by Mole et al. in U.S. Published Patent Application No. 2013/271314 published on Oct. 17, 2013 and entitled “Apparatus and Method to Conserve Power in a Portable GNSS unit”, which published application is incorporated herein by reference in its entirety.

In the arrangement described by Mole et al, usage between a high power-consuming location fixing method and a low power consuming location fixing method is coordinated to reduce the overall power consumption of a portable device without a significant reduction in accuracy. High accuracy, relatively high power consuming location fixes are acquired by a GNSS unit, such as a GPS receiver. The low-power fixes are acquired by an accelerometer, together with software, hardware or firmware for extrapolating a speed based on the force measurements by the accelerometer. In this manner, a GPS receiver can be operated for only a fraction of overall use, primarily to provide adjustment data necessary to calibrate usage of the accelerometer.

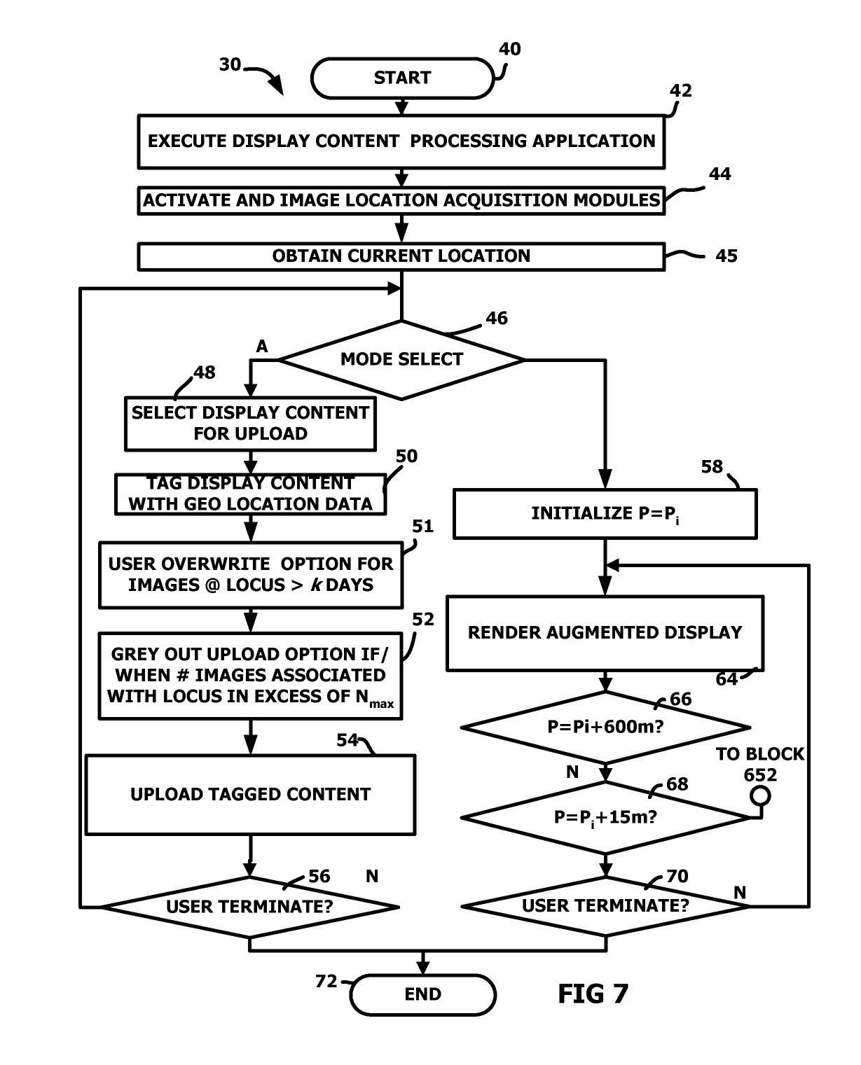

Utilizing an arrangement such as that described by Mole et al, it is possible to acquire location information on a substantially continuous basis at fairly lower levels of power consumption, making this approach ideally suited, though not necessary, for implementing an augmented reality display in accordance with the teachings of the present invention. In alternate embodiments where the rate of power consumption has less priority as a design criterion, substantially continuous measurements may be acquired from an onboard GPS sensor. Where substantially continuous location fixes are available by any of the above described or other techniques, the fixes may be used as inputs to a state machine wherein transitions are monitored to determine the occurrence of specific events. By way of example, and as will be described in greater detail later in connection with the exemplary embodiments of FIGS. 7-9, movement of a user beyond a given distance triggers the execution of specific instructions by the system processor of the device carried by that user.

It suffices to say that the specific manner by which location information can be obtained for enabling the inventive functions and features described herein is well within the capabilities of the artisan of ordinary skill.

Turning now to FIG. 4B, there is shown a table containing some of the data stored in a database associated with a display content repository such as repository 10 of FIG. 1A. To acquire and build this table locally, a device such as device 14 of FIGS. 1A and 1B initiates a request to the associated web server (not shown). In this request, the device requesting retrieval of tagged content reports its position and, for example, any exclusionary or inclusionary criteria such as the interest descriptors described in connection with FIG. 3A. The terms “exclusionary” and “inclusionary” are meant to be mutually exclusive—one can either use the interest descriptors to exclude from downloading any geo-tagged content which has been associated with one or more specified interest descriptors (exclusionary use), or to include only that display content which has been associated with the aforementioned descriptor(s) (inclusionary use).

In any event and with continued reference to FIG. 4C, it will be seen that in this example, eight specific loci are included in the table, though not all of them are associated with every point represented in the table. Loci L₁, I₅ and I₁₀ are within radius r of the applicable communication system in all of the positions represented in the table, which have been captured at increments of 15 meters between initial position P′₁ to P′ₘ. The intermediate points, as points P′ ᵢ₊ⱼ , P′ ₁₊₂j and P′ᵢ₊ⱼ between P′₁ and P′₂, were omitted from FIG. 4A for purposes of clarity and ease of explanation. It will be seen that other loci are only within a circular area defined about a small number of intermediate points or endpoint Pₘ. While only a single media file is shown being associated with each of the respective loci depicted in FIG. 4C, as media file F₁ available in two different resolutions F₁ₐ and F_{1b}, it should be kept in mind that any number of media files may be associated with each loci, and that the tabular representation of FIG. 4C has been greatly simplified for ease of illustration and discussion.

As will now be discussed in greater detail, for each media file associated with the loci represented by FIG. 4C, and at every j meter increment taken by the user traversing a path between initial position P′₁ and final position Pₘ, a distance array is locally constructed and processed by a user's portable communication system. According to embodiments of the present invention, the distance arrays are used to determine how the associated content will be displayed as part of a device's live motion display as the portable communication system is angularly oriented (e.g., moved in an arcuate path defined by either the path along which the user is walking or the motion of the system relative to where the user is standing).

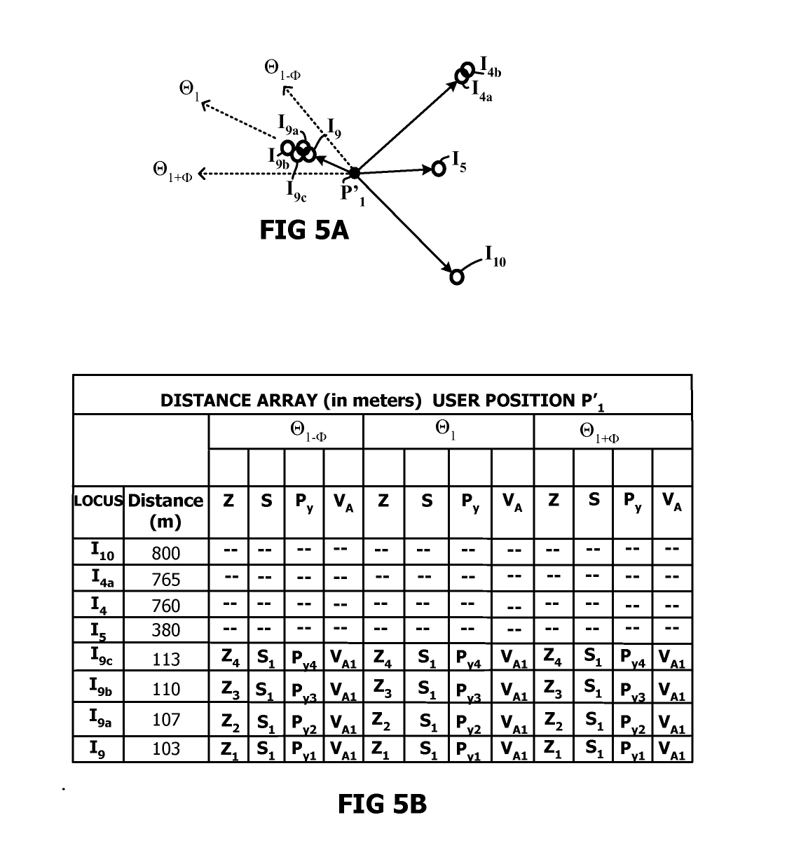

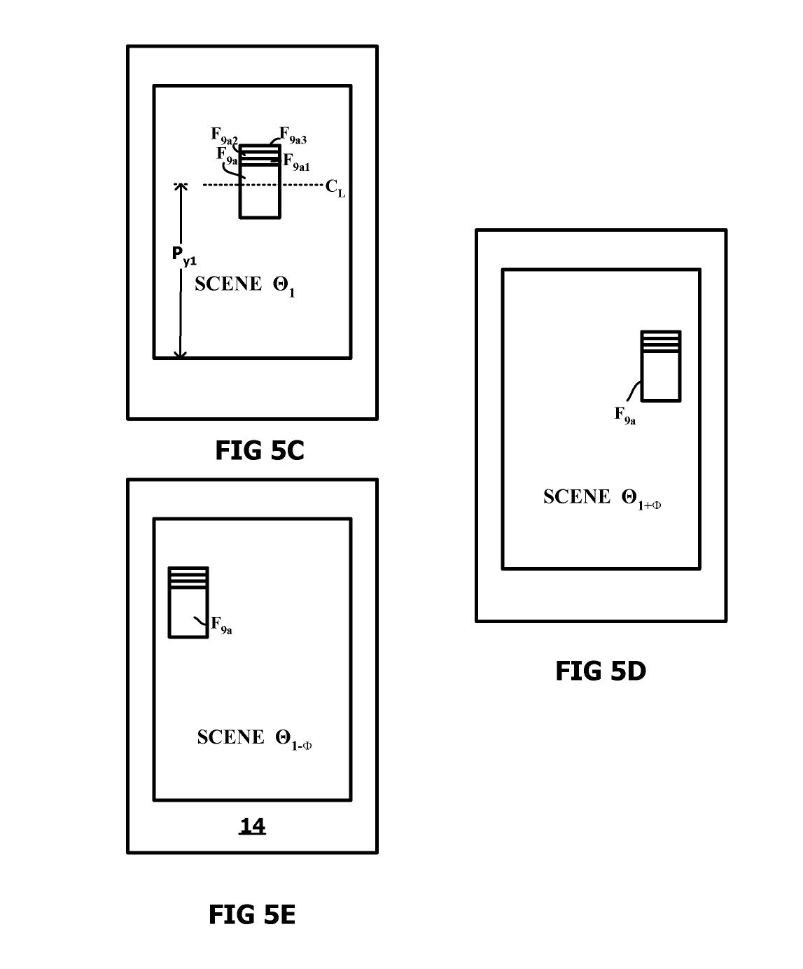

FIG. 5A is a further simplified view of the illustrative zone depicted in FIG. 1A and FIG. 4A, showing the arrangement of a specific set of retrieved display content loci having a relative bearing and relevant distance to the single position P′₁. The table of FIG. 5B contains subset of the data depicted in FIG. 4B—that pertaining to data retrieved by a portable device associated with the user standing or moving through position P′₁, In this array, the data for each image applicable to current position P′₁ is sorted from farthest locus to closest. Thus, locus I₁₀ which is furthest to position P′₁ appears at the top of the array, while locus I₉ is the closest and appears last in the array. The angular orientations (Θ_{1-Φ}, Θ₁, Θ_{1+Φ}) depicted in FIG. 5B correspond to those exemplary orientations shown in FIG. 5A and 5C-5E.

The distance sort carried out in constructing the illustrative array of FIG. 5B is preferably performed from farthest to closest because relatively small angular movements can affect the relative bearing of farther image tagged loci and thus require rapid adjustment in the relative position of these images relative to the displayed scene. Also, by sorting in this manner, if two (or more) images are within the same breakpoint distance (say, for example, greater than thirty meters and less than fifty meters), the closest one can be overlaid upon the other(s). As used herein, “breakpoint” simply means the transition from one range of distances to a closer or further range of distances. According to embodiments of the invention, each breakpoint represents a vertical change in where the image is rendered on the display.

FIG. 5C-5E depict, for the angular orientations relative to P′₁ depicted in FIGS. 5A and 5B, a respective digital representation of a portion of the external environment visible to the user in the direction of a corresponding angular orientation.

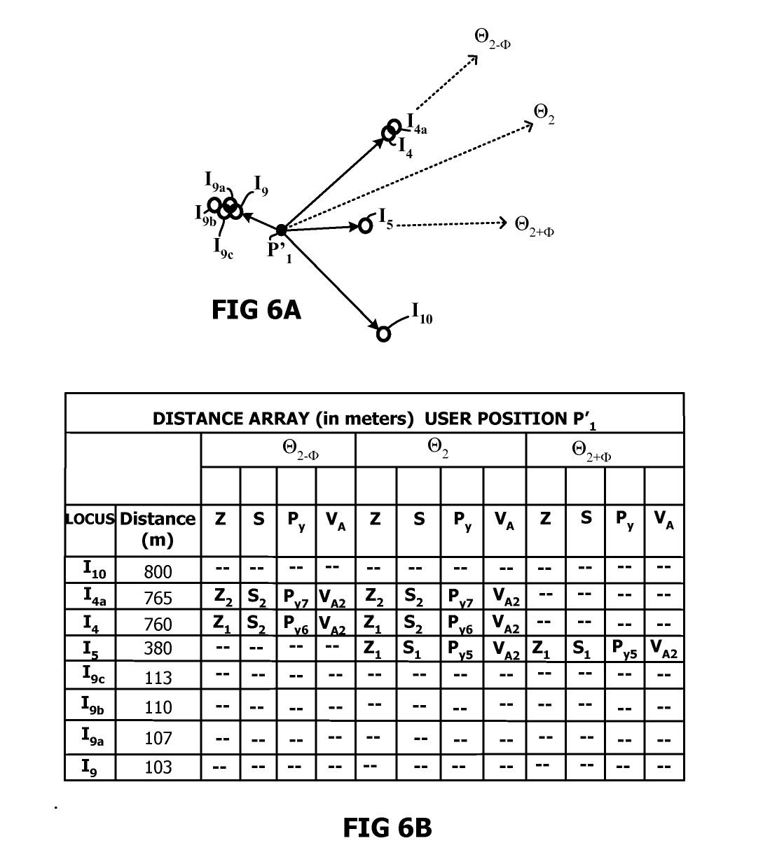

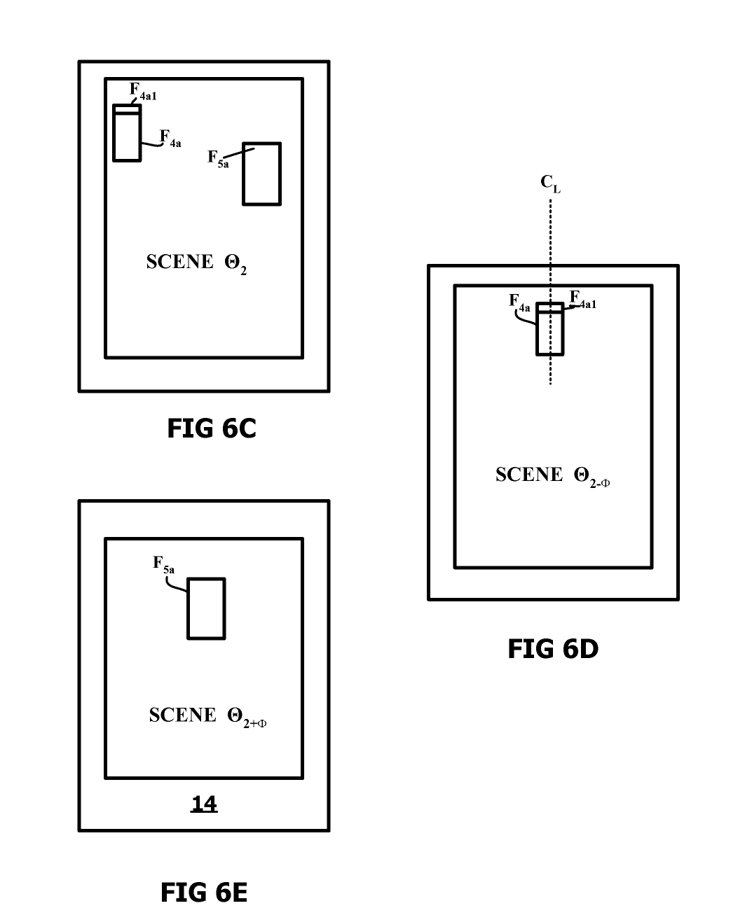

FIG. 6A is a further simplified view of the illustrative zone depicted in FIG. 1A and FIG. 4A, limited to the same set of display content loci shown in FIG. 5A but with reference to different set of exemplary angular orientations (Θ_{2-Φ}, Θ_{2,} Θ_{2+Φ}). The resulting data is sorted and tabulated in the same manner as was the case for FIG. 5B and is shown in FIG. 6B. Collectively, the locally stored array constructed for each media file at each position as P′₁, P′₂ and Pₘ includes display position data P_{xy} corresponds to a number of angular orientations sufficient to provide an acceptable user experience relative to the size of the area for which display content is being processed. FIG. 6C-6E depict, for the angular orientations relative to P′₁ depicted in FIGS. 6A and 6B, a respective digital representation of a portion of the external environment visible to the user in the direction of a corresponding angular orientation.

Among the information contained in the tables of FIGS. 5B and 6B is the Z_{index}. The purpose of the Z_{index} is to address the issue of how to render multiple media files—each potentially having been uploaded by a different user—which “tag” the same locus. In the illustrative example of FIGS. 5A-6B, there are two such loci with this issue. Loci I₄ has been tagged by two different users, the first by image F₄ₐ, and the second by image F₄ₐ₁ Likewise, loci I₉ has been tagged by four different users indicated generally at reference numerals F₉ₐ, F₉ₐ₁, F₉ₐ₂ and F₉ₐ₃, respectively. In the exemplary embodiment represented by FIGS. 5A-6B, the Z_{index} ranks the images on the basis of their proximity to the users, assigning to the closest media file, F₉ₐ, a Z_{index} of Z₁. Z₁ has a higher Z value indicative of a higher order position in a stack where multiple images occupy overlapping areas of the display. Conversely, lower Z values, such as Z2 through Z4, occupy progressively lower positions in the stack. When viewing FIGS. 5D and 5E or FIGS. 6C and 6D, it will be immediately apparent that the resulting images rendered to the display of portable communication system as system 14 of FIG. 1B, are ordered in accordance with their respectively assigned Z_{indee} value. It will, however, be appreciated by those of ordinary skill in the art, that where loci are closely spaced, the multiple images respectively associated with each or the individual images associated with adjacent loci need not be stacked as shown but might alternatively be shown side to side or spread out in some other way to create, for example, the impression of being dispersed in free space.

As can be seen by comparing FIGS. 5C-5E, with FIGS. 6C-6E, it will be seen that the closest image, such as F₉ₐ, associated with locus I₉ (FIG. 5C-5E), is rendered closer to the center of the display screen of portable communication system 20 and has a relatively larger size, while the images associated with locus I₄ (images F₄a and F₄ₐ₁) and locus I₅ (image F5a) is further from the center of the display and each have a smaller size. Since image F5a is closer, however, it occupies a lower position on the screen and, in this example, is slightly larger. Although none of the loci depicted in these examples are closer than 100+ m to the user of the depicted device, in some embodiments the images displayed in accordance with the invention will gradually approach the center of the screen and have the largest scale/size. In illustrative examples, the center position is used for those images associated with tagged loci equal to closer than 15 m. It should, of course, be emphasized that the relationships between distance, image size and position on the display disclosed in FIGS. 5A-5E and FIGS. 6A-6E are for purposes of illustrative example only, and that some, or all of these parameters may be altered, or even remain constant, without departing from the spirit and scope of the present invention.

Other important information contained in the exemplary arrays of FIGS. 5B and 6B include such independently selectable visual attributes as thumbnail and full resolution version image size, and scaling (collectively represented by the single character “S” and such independently selectable visual attributes as border color and opacity represented by the single character V_{A}. The character P_{xy} represents the position of each rendered thumbnail relative to the rendered display of the digital representation of the external environment visible to the user. It may be made by reference to a distance between a selected datum point, line or plane and be represented as distance between the datum and the centroid of each image. At a minimum it will specify a vertical position, with the horizontal component being determined by the angular orientation of the system as described previously. It suffices to say that the aforementioned attributes allow the rendered display to reflect the distance, significance, relative proximity and bearing in a facile, responsive manner.

Turning now to FIGS. 7-9 processes for implementing exemplary embodiments will now be described. With particular reference to FIG. 7, it will be seen that the process 30 is entered at start block 40 and proceeds to block 42, whereupon the user of a portable communications system such, for example, as a mobile terminal equipped with GPS and a live motion camera, causes a processor associated with such system to execute a display content processing application residing in local memory. Instructions executed by the processor according to the application program include, at block 44, activating a location acquisition module to acquire the current location of the system, a display to visually present mode select and other features to the user, and an image acquisition module for capturing one of live motion video or still images representative of a portion of the external environment visible to the user at this time. At block 45, the location tracking module begins to continuously monitor the location of the associated portable communication system At decision block 46, a mode select option is displayed to the user, at which point the user selects between first and second modes of operation indicated generally at A and B, respectively.

If the user selects operation in accordance with the first mode of operation, the process 30 proceeds to block 48, at which point a user standing in close proximity to a site of interest (say, for example, 1-15 meters) identifies one or more images, video, or still photos constituting display content he or she would like to upload. At block 50, the program application being executed by the processor of the portable communication system makes an association between the acquired location and the media file(s) selected by the user. According to some embodiments, if there are any images already associated with the location which are over k days old (e.g., three days old), a menu option is rendered at block 51 to allow the user to overwrite the older content. Additionally or alternatively, a processor associated with a remote web server determines whether more than a maximum number Nₘₐₓ images (e.g., eight geo-location-tagged media files) have already been associated with the current locus at which the user and associated portable communication device are currently positioned. If so, at block 52, the processor executes responsively instructions which disable (e.g., “grey out” a displayed option to tag/upload data until the user moves a sufficient distance away.

The optional functions represented by blocks 50 and 51 can be utilized together, as well. For example, say five images associated with a particular locus are less than three days old, and three of the images are more than three days old. A user can be given the option of selecting which of the three “stale” images he or she would like to replace with display content of his or her own choosing. In other embodiments, the “tag over” option of block 51 is made available to users without regard to the number of pre-existing images that are already associated with a given location. So, even though a location may only have three images already associated with it, a subsequent user may tag over that display content whose age exceeds a selectable threshold. The process proceeds to block 54, at which time the media files and associated located data are uploaded either to a remote database administered via a web server or to some other location from which it can be accessed by one or more additional users (e.G, a peer-to-peer endpoint having a memory containing executable instruction which allow that endpoint to respond to requests by other users).

The process then proceeds to decision block 56. If the user elects to terminate, then the process terminates at “end' block 72. If, however, the user wishes to continue tagging other loci in the vicinity with the same or other media files locally stored or remotely retrievable by his or her device, decision block returns to block 48 whereupon the user is free to select additional files and move to a different location. By way of alternative example, decision block 56 might pass operation to mode select decision block 46, to allow the user to switch from operation in accordance with first mode A to second mode B.

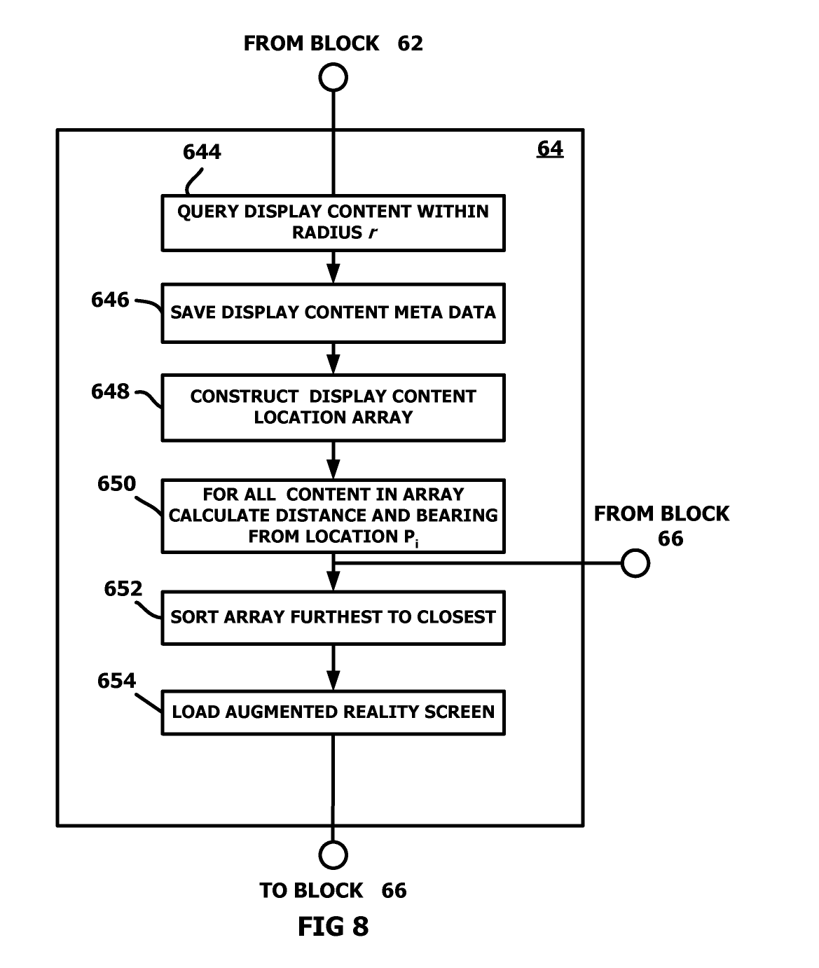

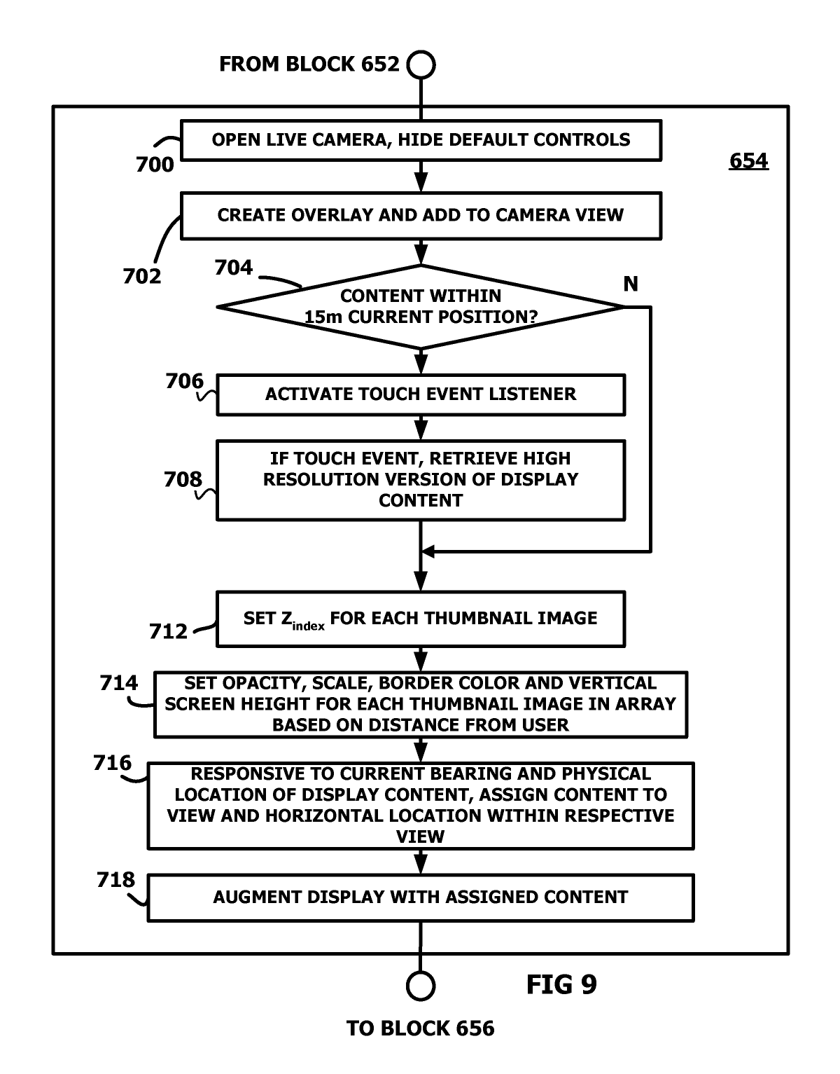

If the second or “augmented reality display” mode of operation is elected by the user at decision block 46, the process proceeds to block 58. At block 58, the currently acquired location is used to initialize the process at block 62, wherein the process proceeds to a step of rendering an augmented display combining a digital representation of the external environment visible to the user as he or she is moving toward, away, between and among various loci of interest such as those tagged with media file content by users operating devices in accordance the aforementioned first mode of operation. This display rendering step is indicated generally and in summary form at block 64 in FIG. 7, with a more detailed discussion of rendering process being deferred until the discussion of FIGS. 8 and 9.

With continuing reference to FIG. 7, it will be seen that from block 64, the process proceeds to decision block 66. If the aforementioned location information reveals that the user has moved more than 600 m from position P, then the process is re-initialized at block 62. This ensures that the portable communication device has images which are relevant to a newly entered location. At block 68, once location module determine that the user has moved more than 15 m in any direction from position P, the process proceeds to block 652 (FIG. 8). If not, then the process proceeds to decision block 68. If not, and the user does not terminate operation in the augmented reality mode of operation at block 70, the process returns to block 64. If the user does elect to terminate, then the process ends at block 72. Rather than terminate, and as already described before, the user may be presented with the opportunity to toggle between the first and second modes, at which point the process would merely return to decision block 46 rather than block 72.

With reference now to the exemplary embodiment of FIGS. 8 and 9, the sub steps performed within the block indicated generally reference numeral 62 in FIG. 7 will now be described in detail. As seen in FIG. 8, the display rendering sub process 62 is entered at step 644, wherein the portable communication system is operated to query the remote repository as the web server and database of repository 10 in FIG. 1A. This querying process may be preceded by an authentication process in which the user provides a user name and password to gain access to display content served by the repository. At block 644, the portable communication system is configured to request all display content responsive to its query, which query can specify either a specific radius or geographic subdivision or it can simply report its current position in which case the processor associated with the repository web server makes the appropriate selection. The query may further specify an interest descriptor as described previously, to apply exclusionary or inclusionary filtering to the retrieval request. Alternatively, the user may have set up a personal profile accessible by the web server such that the descriptor need not be included as part of the actual query process.

Depending on the location specified by the user during the query process at block 644, there may be display content associated with loci close enough to warrant the availability of higher resolution images during the local rendering process. In this case, the file locations and/or http addresses of each of the high and low resolution images are located by the depository web server as part of the query process in preparation for download to the user's portable communication system. Unless this is the case, however, the initial results returned for any given display content identified during the query process will include only low resolution images in order to conserve bandwidth and minimize consumption of processing resources.

In any event, and with particular reference to FIG. 8, it will be seen that the process then proceeds to block 646, where the display content identified during the query process is retrieved by and saved to local memory of the portable communication system. At block 648, a display content location array is constructed, and then the process proceeds to block 650 where the current location of the user's portable communication system is compared against the loci associated with the retrieved display content array organized during block 648. At block 652, the retrieved display content in the array is sorted on the basis of its distance to the current location.

Once the sorting operation is complete, which results in an organization of data similar to that tabulated in FIGS. 5B and 6B, the process proceeds to block 654 where the digital representation of the external environment visible to the user—which is displayed to the user via operation of the portable communication system and corresponds to the direction at which the image acquisition module is pointed to capture live motion video—is augmented to include the applicable display content based on distance, bearing and the various attributes set in the array. Because the array is pre-populated with all of the data needed to render the display using conventional image processing techniques, there is no delay even though the user may make rapid movements of the image acquisition module. As a result, and the user is presented in real time with a digital representation of augmented reality version of the externally visible environment, the only difference between what the user sees with their own eyes and the through the display of the communication system being that the live motion presented by the latter has been tagged with, for example, “digital graffiti” that can only be seen by users operating their devices according to the principles of the present invention.

Turning now to FIG. 9, the various sub steps which comprise step 654 of exemplary process 30 will now be described in detail. As seen in FIG. 9, the process proceeds from block 652 to block 700, whereupon a live camera or other image acquisition module is activated and the default controls associated with the operation of the camera are suspended. At block 702 a user interface overlay is generated and rendered using conventional digital processing techniques to cause the superposition of the overlay controls and features on the camera view being displayed. If there is display content in the distance array associated with a locus within 15 m of where the user is situated, the process proceeds to block 706, wherein a touch event listener is activated. Touch event listener is added to the region of the screen which underlies the rendered thumbnail images, allowing the portable communication system to respond to user input representative of a selection by retrieving and displaying a higher resolution, full size version of the selected display content previously rendered as a thumbnail image. . Any images outside of the 15 m threshold are rendered at a lower image resolution. Using a thumbnail image size of 75×75 pixels, it is suggested that x should be a number no greater than 8 images for a smart phone, with provisions for a greater number being possible, but not mandatory for tables and other devices having larger displays. Before proceeding further, it should be emphasized that the 15 m threshold used in the above-mentioned steps are by way of illustration only, as may be recalled from the prior discussion of FIG. 4C.

In any event, and with continued reference to FIG. 9, it will be seen that the process proceeds to block 708, wherein if a touch event is recognized indicative of a user's selection of a locus-tagging image, then a higher resolution version of the image is downloaded and displayed (if not already locally stored). Along with the image, other content such as comments associated with the image can be rendered to the display, along with a dialog box offering the user an opportunity to append comment(s) to the image.

The process then proceeds to block 712. At block 712, the Z_{index} is set for each thumbnail image, and then at block 714, such visual attributes as the opacity, size, scale, border color and vertical screen height are set based on their distance from the user. According to some embodiments, a higher Z_{index} value corresponds with closer locus distances to the user's location and a lower Z_{index} corresponds to farther distances to the user's location. At block 716, responsive to the current loci associated with respective display content, the content is assigned to a conventional image processing engine at block 718, which causes the display content to be rendered as part of the scene acquired by the camera. The process thereafter proceeds to block 656 (FIG. 8) where in the location is updated. Finally, the process is returned to decision block 66.

It is believed that other modifications, variations and changes will be suggested to those skilled in the art in view of the teachings set forth herein. It is therefore to be understood that all such variations, modifications and changes are believed to fall within the scope of the present invention. Although specific terms are employed herein, they are used in their ordinary and accustomed manner onl_{y, un}less expressly defined differently herein, and not for purposes of limitation.

What is claimed is:

1. A method of operating a portable communication system including a display, a transceiver, a memory containing executable instructions, an image acquisition module, a location acquisition module, and a processor operatively associated with the memory, display, transceiver and image acquisition system, the method comprising:
acquiring, using the image acquisition module, a digital representation of an external environment visible to a user of the portable communication system, the external environment encompassing respective sets of coordinates in three dimensional space;
acquiring, using the location acquisition module, a first location estimate for the portable communication system;
retrieving a first media file having geo-location information corresponding to a first set of coordinates encompassed by the external environment;
rendering, on the display, the external environment visible to the user from a first distance and bearing from a locus associated with the first media file together with an image derived from the first media file,
wherein the image derived from the first media file is rendered so as to appear in substantial linear alignment between an acquired location of the portable communication device and the first set of coordinates.

2. The method of claim 1, further including
acquiring, in a second image acquiring step, a digital representation of an updated external environment visible to the user of the portable communication system, the updated external environment encompassing at least some of the respective sets of coordinates in three dimensional space; and
rendering on the display, in a second rendering step, the updated external environment visible to the user at together with an image derived from the first image file.

3. The method of claim 2, wherein an image derived from the first image file and rendered during the second rendering step differs in at least one visual characteristic compared to a previously rendered image derived from the first image file.

4. The method of claim 3, wherein the visual characteristic is size, wherein the image derived from the first image file and rendered during the second rendering step has a larger appearance in the display at a subsequent location of the portable communication device closer to the first set of coordinates than an earlier location of the portable communication device.

5. The method of claim 4, wherein the image derived from the first image file and rendered during the second rendering step has a smaller appearance in the display at a subsequent location of the portable communication device farther from the first set of coordinates than an earlier location of the portable communication device.

6. The method of claim 3, wherein the visual characteristic is opacity, wherein the image derived from the first image file and rendered during the second rendering step has a more opaque appearance in the display at a subsequent location of the portable communication device closer to the first set of coordinates than an earlier location of the portable communication device.

7. The method of claim 6, wherein the visual characteristic is opacity, wherein the image derived from the first image file and rendered during the second rendering step has a more translucent appearance in the display at a subsequent location of the portable communication device farther to the first set of coordinates than an earlier location of the portable communication device.

8. The method of claim 1, wherein the retrieving step comprises receiving the first image file over a wireless communication link from a server having access to a database containing a plurality of digital image files each having geo-location information associated therewith.

9. The method of claim 8, further including a step of executing instructions stored in memory, using the processor, to upload a second digital image file to the server together with geo-location information captured by the location acquisition module.

10. The method of claim 1, further including steps of executing instructions stored in memory, using the processor of the first portable communication system, to retrieve a second digital image from the memory of the first portable communication system and to transmit, for remote access by others, the second digital image together with geo-location information captured by the location acquisition module.

11. The method of claim 10, further including steps of
acquiring, using a location acquisition module of a second portable communication system used by a second user, a second location estimate for the second portable communication system;
retrieving the second digital image file including associated geo-location information over a communication link;
rendering, on the display of the second portable communication system, an external environment visible to the second user together with an image derived from the second digital image file,
wherein the image derived from the second image file is rendered on the display of the second portable communication device so as to appear in substantial linear alignment between an acquired location of the second portable communication device and a set of coordinates associated with the second digital image file.

12. A method for processing digital image files each having respectively associated therewith corresponding geo-location information, the method comprising the steps of:
receiving at a server, in a first receiving step, a first digital media file having associated therewith a set of coordinates in three dimensional space, the set of coordinates having been acquired by operation of a location acquisition module of a first portable communication device operated by a first subscriber;
storing the first digital media file in a database associated with the server;
receiving at the server, in a second receiving step, a location estimate acquired by a location acquisition module of a second portable communication system and transmitted to the server over a wireless communication link, the second portable communication system being operated by a second user;
determining whether any digital media file and associated geo-location information is relevant to the second user based on at least one criterion.

13. The method of claim 12, wherein the at least one criterion includes the location estimate received during the second receiving step and a criterion identified by the user of the second portable communication system

14. The method of claim 13, wherein the at least one criterion identified by the user of the second portable communication system further includes a common interest descriptor including at least one of an alumni association, a professional sports team, a religious organization, a fraternal organization, or an academic institution.

15. The method of claim 12, further including, responsive to the determining step,
retrieving, from the database, the first digital image file and associated set of coordinates in three dimensional space if determined to relevant to the second user based on the determining step; and
transmitting, over a communication link, the first digital image and associated geo-location information to the second portable communication system.

16. The method of claim 12, further including associating a personal profile with each user authorized to upload digital image files with associated geo-location data.

17. The method of claim 116, further including a step of authenticating each user as an authorized user prior to accepting a digital image file for storage in the database.
